(19) United States
(12) Patent Application Publication
(10) Pub. No.: US 2022/0076124 A1
(43) Pub. Date: Mar. 10, 2022

(54) METHOD AND DEVICE FOR COMPRESSING A NEURAL NETWORK

(71) Applicant: Robert Bosch GmbH, Stuttgart (DE)

(72) Inventors: Fabian Timm, Renningen (DE); Lukas Enderich, Stuttgart (DE)

(21) Appl. No.: 17/395,845

(22) Filed: Aug. 6, 2021

(30) Foreign Application Priority Data
Sep. 8, 2020 (DE) 102020211262.2

(51) Int. Cl. G06N 3/08

(52) U.S. Cl. CPC G06N 3/082; G06N 3/0481

(57) ABSTRACT

A method for compressing a neural network. The method includes: defining a maximum complexity of the neural network; ascertaining a first cost function; ascertaining a second cost function, which characterizes a deviation of a current complexity of the neural network in relation to the defined complexity; training the neural network in such a way that a sum of a first and a second cost function is optimized as a function of parameters of the neural network; and removing those weightings whose assigned scaling factor is smaller than a predefined threshold value.

### CROSS REFERENCE

The present application claims the benefit under 35 U.S.C. § 11 of German Patent Application No. DE 102020211262.2 filed on Sep. 8, 2020, which is expressly incorporated herein by reference in its entirety.

### FIELD

The present invention relates to a method for compressing a deep neural network as a function of a predefinable maximum complexity, as well as to a device, to a computer program, and to a machine-readable memory medium.

### BACKGROUND INFORMATION

Neural networks may be used for various tasks for driver assistance or for automated driving, for example for the semantic segmentation of video images in which individual pixels are classified into different categories (pedestrian, vehicle, etc.).

Current systems for driver assistance or for automated driving, however, require special hardware, in particular, due to the safety and efficiency requirements. For example, special microcontrollers having limited computing and memory capacity are used. These limitations, however, represent particular requirements with regard to the development of neural networks since neural networks are usually trained on supercomputers using mathematical optimization methods and floating point numbers. If the trained weights of a neural network are subsequently simply removed, so that the reduced neural network may be calculated on the microcontroller, its performance capability decreases dramatically. For this reason, particular training methods are necessary for neural networks, which even achieve excellent results with a reduced number of learned filters in embedded systems, and may be trained quickly and easily.

The authors Zhuang Liu, Jianguo Li, Zhiqiang Shen, Gao Huang, Shoumeng Yan, and Changshui Zhang, in their paper “Learning efficient convolutional networks through network slimming.” CoRR, abs/1708.06519, retrievable online: https://arxiv.org/pdf/1708.06519.pdf, describe a method for compressing convolutional neural networks via a weighting factor, obtained from batch normalization layers.

### SUMMARY

It is advantageous that, based on an example embodiment of the present invention, after training, at the most as many parameters and multiplications remain as were defined prior to training.

During training, weights or filters are globally removed, i.e., a global optimization of the weights or a filter reduction occurs in the entire neural network. This means that, during a compression over, e.g., 80%, in the method according to an example embodiment of the present invention, this compression is independently distributed among the different layers of the neural network. This means that the local reduction rates of the individual layers are then determined by the method according to the present invention. This results in particularly low performance losses at considerably increased computing efficiency of the compressed neural network since fewer computing operations have to be carried out.

In light of the fact that all network layers collectively contribute to the learning task, it is inadequate to remove individual layers independently of one another. Here, an example embodiment of the present invention may have the advantage that the interaction of the individual weights or filters is taken into consideration, by which no to little performance reduction occurs after the compression.

Further advantages result from the compressed machine learning system, obtained by an example embodiment of the present invention: The calculation time, the energy consumption, and the memory requirement are directly reduced, without necessitating special hardware.

Consequently, the limited resources of the computer, such as memory/energy consumption/computing power, may be taken into consideration during the training of the neural network.

An object of the present invention is a training of neural networks, which ultimately only has a maximally predefined number of parameters and multiplications.

In a first aspect, the present invention relates to a method for compressing a neural network. The neural network includes at least one sequence of a first layer, which carries out a weighting, in particular, a weighted summation, of its input variables and outputs them as output variables, and a second layer, which carries out an affine transformation, as a function of scaling factors γ, of its input variables and outputs them as output variables. It shall be noted that the affine transformation may additionally include a shifting coefficient β, by which the input variable is shifted as a result of the affine transformation, in particular, along the x axis. A weighting may be understood to mean a predefined set of weights of a multitude of weights of the first layer. For example, the rows of a weight matrix of the first layer may be regarded as weightings. A respective scaling factor γ from the second layer is assigned to the weightings of the first layer. The assignment may take place in such a way that the scaling factors are assigned to those weightings from the first layer whose input variables the respective scaling factor scales, or which the respective scaling factor scales as a function of the output variable ascertained by the respective weighting. As an alternative, the assignment of the scaling factors to the weightings may take place in such a way that the sets of weights (weightings) in each case correspond to channels, and each channel is assigned those scaling factors which scales an input variable or output variable of the particular channel.

It shall be noted that the sequence encompasses both the specific sequence “first layer subsequently connected to the second layer” and the specific sequence “second layer subsequently connected to the first layer.” It shall furthermore be noted that the neural network is preferably a convolutional neural network, and the first layer is preferably a convolutional layer which convolutes its input variables with a multitude of filters, the filters being the weightings of the first layer. Each filter may represent a channel in the process. The second layer is preferably a batch normalization layer.

In accordance with an example embodiment of the present invention, the method of the first aspect includes the following steps:

Defining a maximum complexity. The complexity characterizes a consumption of computer resources of the first layer, in particular, a countable property of an architecture of the first layer, during a forward propagation. The complexity preferably characterizes a maximum number of multiplications M* or/and parameters P* of the neural network. In addition or as an alternative, the complexity may characterize a maximum number of output variables of the layers. The complexity may relate to the first layer or to all layers, i.e., the entire neural network. The complexity preferably relates to the entire neural network.

The parameters for the complexity of the neural network may be understood to mean all learnable parameters. These parameters are preferably understood to mean the weights or filter coefficients of the layers of the neural network. The maximum number of multiplications may be understood to mean the number of all executed multiplications of the neural network or layer which may maximally be executed by the neural network for a propagation of an input variable of the neural network.

This is followed by an ascertainment of a first cost function L_{learning}, which characterizes a deviation of ascertained output variables of the neural network in relation to predefined output variables from training data.

This is followed by an ascertainment of a second cost function L_{pruning}, which characterizes a deviation of a current complexity \tilde{P},\tilde{M} of the neural network in relation to the defined complexity P*,M* the current complexity \tilde{P},\tilde{M} being ascertained as a function of a number of scaling factors which have an absolute value greater than a predefined threshold value t.

This is followed by a training of the neural network in such a way that a sum of a first and second cost function is optimized as a function of parameters of the neural network. The neural network may be pretrained, i.e., training was already carried out for a multitude of epochs using only the first cost function.

This is followed by a removal of those weightings of the first layer whose assigned scaling factor has an absolute value smaller than predefined threshold value t. In addition, the second layer may be integrated into the first layer by additionally implementing the affine transformation of the second layer for the first layer.

As an alternative, after the training using both cost functions, the weightings may be deleted whose scaling factor, in absolute terms, is smaller than the threshold value by setting both the scaling factor and the shifting coefficient to the value 0.

It is provided that the current number of scaling factors γ, in each case applied with the aid of a sum across indicator functions Φ(γ,t), is ascertained for each scaling factor, the indicator function outputting the value 1 when the absolute value of the scaling factor is greater than threshold value t, and otherwise outputs the value 0. The current complexity \tilde{P},\tilde{M} is then ascertained, as a function of the sum of the indicator functions, standardized to a number of the calculated weightings of the first layer, multiplied by the number of the parameters or multiplications from the first layer.

Furthermore, it is provided that the neural network includes a multitude of the sequences of the first and second layers. The complexity of the first layers is then ascertained, standardized to a number of the calculated weightings of the first layer, in each case as a function of the sum of the indicator functions. The current complexity \tilde{P},\tilde{M} is ascertained as the sum across the complexities of the first layers, multiplied in each case with the complexity of the immediately preceding first layer, and multiplied with the number of parameters or multiplications from the respective first layer. The multiplication with the complexity of the immediately preceding first layer has the advantage that it may thus be taken into consideration that the computing complexity of the subsequent layer automatically decreases during a compression of the immediately preceding layer.

It is furthermore provided that the second cost function L_{pruning} is scaled with a factor λ, factor λ being selected in such a way that a value of the scaled second cost function corresponds to an ascertained first value of the first cost function at the beginning of the training. For example, the first value may correspond to the ascertained value of the first cost function for the neural network which was initialized at the beginning of the training using random weights. It has been found that, during this scaling of the second cost function, its influence on the sum of the cost functions is ideal to achieve the lowest performance reduction after removal of the weightings.

It is furthermore provided that, at the beginning of the training, factor λ of the second cost function is initialized using the value 1 and, each time the execution of the step of training is repeated, factor λ is incrementally increased until it assumes this value, so that the scaled second cost function having factor λ corresponds, in absolute terms, to the first cost function at the beginning of the training. It has been found that this so-called “heat-up” of factor λ allows the best results to be achieved with respect to a swift convergence of the training and the fulfillment of the goal of maximum complexity.

It is furthermore provided that the neural network is at least partially trained, in particular, subsequently trained, after the removal of the weightings as a function of the first cost function. Partial may be understood to mean that only a selection of the weightings, and optionally only over a small number of epochs, preferably 3 epochs, the neural network is only subsequently trained. This corresponds to a fine tuning of the compressed neural network.

It is furthermore provided that the compressed neural network, which was compressed according to the first aspect, is used for computer-based vision (computer vision), in particular, for image classifications. In the process, the neural network may be an image classifier, the image classifier assigning its input images to at least one class made up of a multitude of predefined classes. The image classifier preferably executes a semantic segmentation, i.e., a pixelwise classification, or a detection, i.e., whether an object is present/not present. Images may be camera images or radar/LIDAR/ultrasound images or a combination of these images.

It is furthermore provided that the compressed neural network, which was compressed according to the first aspect, ascertains, as a function of a detected sensor variable of a sensor, an output variable which may thereupon be used to ascertain a control variable with the aid of a control unit.

The control variable may be used to control an actuator of a technical system. The technical system may, for example, be an at least semi-autonomous machine, an at least semi-autonomous vehicle, a robot, a tool, a factory machine or a flying object, such as a drone. The input variable may be ascertained as a function of detected sensor data, for example, and be provided to the compressed neural network. The sensor data may be detected by a sensor, such as a camera, of the technical system or, as an alternative, be received from the outside.

In further aspects, the present invention relates to a device as well as to a computer program, which are each configured to execute the above methods, and to a machine-readable memory medium on which this computer program is stored.

Specific embodiments of the present invention are described hereafter in greater detail with reference to the figures.

### BRIEF DESCRIPTION OF THE DRAWINGS

FIG. 1 schematically shows a flowchart of one specific example embodiment of the present invention.

FIG. 2 schematically shows one exemplary embodiment for controlling an at least semi-autonomous robot, in accordance with the present invention.

FIG. 3 schematically shows one exemplary embodiment for controlling a manufacturing system, in accordance with the present invention.

FIG. 4 schematically shows one exemplary embodiment for controlling an access system, in accordance with the present invention.

FIG. 5 schematically shows one exemplary embodiment for controlling a monitoring system, in accordance with the present invention.

FIG. 6 schematically shows one exemplary embodiment for controlling a personal assistant, in accordance with the present invention.

FIG. 7 schematically shows one exemplary embodiment for controlling a medical imaging system, in accordance with the present invention.

FIG. 8 shows a possible setup of a training device in accordance with an example embodiment of the present invention.

### DETAILED DESCRIPTION OF EXAMPLE EMBODIMENTS

For a specific learning task (e.g., classification, in particular, semantic segmentation), usually a corresponding first cost function L_{learning} as well as a neural network or a network architecture therefor are defined. First cost function L_{learning} may be an arbitrary cost function (loss function), which mathematically characterizes a deviation of the output of the neural network in relation to labels from training data. Neural networks are made up of layers which are connected to one another. As a result, the neural network is defined prior to the training by a sequence of layers. The individual layers carry out weighted summations of their input variables, or may carry out linear or non-linear transformations of their input variables. The layers having weighted summations are referred to hereafter as first layers. The weighted summations may be carried out with the aid of a matrix-vector multiplications or with the aid of convolutions. For the matrix-vector multiplications, the rows of the matrix correspond to the weightings, and for the convolution, the filters correspond to the weightings. After each of these layers, a layer having an affine transformation may be integrated into the neural network. These layers are referred to hereafter as second layers. The layer including the affine transformation is preferably a batch normalization layer.

The layers are usually oversized since initially it is not predictable how many parameters are required for the particular learning task.

However, it is not taken into consideration in the process that, after the training has ended, the neural network is to have a maximum predefinable number of parameters and multiplications which is to be lower than the initially selected number of parameters. The goal is thus to deliberately compress or reduce the neural network, either already during the training or after the training, so that the neural network includes only this predefined number, and thus achieves the best possible performance using limited resources. The compression is to be carried out in such a way that weights are removed from the neural network.

For this purpose, it is provided that a second cost function L_{pruning} is used during training. This additional cost function is used together with first function L_{learning}: L=L_{learning}+λL_{pruning}, λ serving as a weight factor between the two cost functions. λ is preferably selected in such a way that the value of second cost function λL_{pruning}, including its multiplication with λ, approximately corresponds to the value of the first cost function at the beginning of the training process.

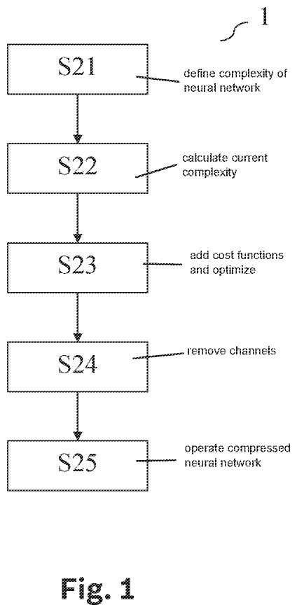

The compression of the neural network using the second cost function may be executed as follows. FIG. 1 shows a flowchart (1) of this method in this regard by way of example.

In a first step S21, a complexity of a neural network is defined based on the number of parameters P and/or the number of multiplications M. If limited computing resources, corresponding to a maximum complexity P* and M*, are now available, current complexity \tilde{P} and \tilde{M} are optimized by training the neural network using the following cost function:

$${L}_{pruning} = r e l u ( \frac{\tilde{P} - {P}^{*}}{P} ) + r e l u ( \frac{\tilde{M} - {M}^{*}}{M} )$$

The available complexity or target complexity P*,M* of the neural network may be ascertained as a function of the properties of the hardware to be executed of the compressed neural network. The properties may be: available memory space, computing operations per second, etc. For example, the maximum number of parameters may be directly derived from the memory space with a predefinable resolution.

In one further exemplary embodiment, additionally or alternatively an upper limit for the number of output variables per layer may be used as the maximum complexity. This number may be derived from the bandwidth of the hardware.

For counting parameters \tilde{P} and multiplications \tilde{M} during the training, an indicator function ϕ is applied to scaling factors γ of the batch normalization layer:

$$Φ ( γ , t ) = \{ \begin{matrix}0 , & falls \vert γ \vert \leq t \\ 1 , & falls \vert γ \vert > t\end{matrix} ,$$

where t is used from the value range [10⁻¹⁵; 10⁻¹], for example t=10⁻⁴.

An indicator function is thus used, which includes scaling factor γ as an argument. The output of the indicator function may be interpreted in such a way that the value zero indicates an inactive channel which may be deleted.

It is possible to say that each layer includes multiple channels, the number of channels in an output variable of a layer corresponding equal to the number of the convolution filters or matrix rows of the weight matrix.

In the case of a batch normalization layer, each channel is normalized and linearly transformed after the weighted sums have been calculated. The standardized output variable of the batch normalization layer is calculated as a function of an expected value μ and a variance σ of a batch of training data. The standardized output variable is thereupon additionally also ascertained as a function of learnable parameters γ,β. If the values of the learnable parameters are close to zero, the channel loses its influence on the output of the network. The two learnable parameters have the advantage that they may “denormalize” the output variable of the normalization layer, e.g., in the event that it is not useful to shift and scale the input variable of the batch normalization layer by the expected value and the variance. For more details in this regard, see Ioffe, Sergey, and Christian Szegedy. “Batch normalization: Accelerating deep network training by reducing internal covariate shift.” arXiv preprint arXiv:1502.03167 (2015), retrievable online: https://arxiv.org/pdf/1502.03167.pdf. After the training, batch normalization layers may be integrated into the preceding/subsequent convolution or fully connected layer to expedite the inference graph. Normalized output variable âₗ of the layer which executes a weighted summation may thus, in general, be represented as:

âₗ=ŵₗ*xₗ₋₁+\hat{b}ᵢ

where

$${\hat{w}}_{l} = {w}_{l} \frac{{γ}_{l}}{\sqrt{{σ}_{l}^{2} + ϵ}}$$

$$and$$

$${\hat{b}}_{l} = ( {b}_{l} - {μ}_{l} ) \frac{{γ}_{l}}{\sqrt{{σ}_{l}^{2} + ϵ}} {β}_{l}$$

where operation * denotes a convolution or a (matrix) multiplication, and ∈ denotes a bias for the numerical stability so that no division by 0 occurs. Preferably ∈=10⁻⁵.

It shall be noted that, for values |γ|<10⁻⁴, normalized output variable âₗ approximately corresponds to value \hat{b}ₗ, which is independent of the channel input, and thus only corresponds to a constant bias. This bias is propagated by the subsequent convolution or the fully connected layer and shifts the resulting output variable. This shift, however, is corrected by a subsequent batch normalization layer in that the mean value across the respective mini batch is subtracted.

This allows scaling factor γ and shifting coefficient β of the batch normalization layers to be set to zero after the neural network has been trained when the indicator function outputs zero.

After step S21, step S22 follows. Herein, \tilde{P} may be calculated as follows:

$$\tilde{P} = {\sum }_{l = 1}^{L - 1} {P}_{l} ( \frac{1}{{C}_{l - 1} {C}_{l}} {\sum }_{c = 1}^{{C}_{l - 1}} Φ ( {γ}_{l - 1} , c ) {\sum }_{c = 1}^{{C}_{1}} Φ ( {γ}_{l} , c ) ) + {P}_{L} ( \frac{1}{{C}_{L - 1}} {\sum }_{c = 1}^{{C}_{L - 1}} Φ ( {γ}_{L - 1} , c ) )$$

Here, l denotes the layer index, L denotes the total number of layers, Cₗ denotes the number of channels in layer l, and Pₗ denotes the current number of parameters in layer l.

And \tilde{M} correspondingly with:

$$\tilde{M} = {\sum }_{l = 1}^{L - 1} {M}_{l} ( \frac{1}{{C}_{l - 1} {C}_{l}} {\sum }_{c = 1}^{{C}_{l - 1}} Φ ( {γ}_{l - 1} , c ) {\sum }_{c = 1}^{{C}_{1}} Φ ( {γ}_{l} , c ) ) + {M}_{L} ( \frac{1}{{C}_{L - 1}} {\sum }_{c = 1}^{{C}_{L - 1}} Φ ( {γ}_{L - 1} , c ) )$$

Thus, L_{pruning} after each “forward path” of the training penalizes the deviations between setpoint parameter number P* and actual parameter number \tilde{P} as well as setpoint multiplications M* and actual multiplications \tilde{M}.

After step S22, step S23 follows. In this step, the two cost functions are added up and optimized with the aid of an optimization method, preferably with the aid of a gradient descent method. This means that the parameters of the neural network, such as filter coefficients, weights, and scaling factors γ, are adapted in such a way that the sum of the cost functions is minimized or maximized.

The corresponding gradients may be back-propagated by the neural network by forming the gradients of indicator function Φ(γ,t).

A straight-through estimator (STE) may be used for the gradient of the indicator function. For more details regarding the STE, see: Geoffrey Hinton. Neural networks for machine learning. Coursera, video lecture, 2012. Since indicator function Φ is symmetrical to the y axis, the following adaptation of the gradient estimator may be used: dΦ/dγ=−1 for γ≤0 and 1 for γ>0.

After step S23 has been completed, it may thereupon be repeated multiple times until an abort criterion is met. The abort criterion may, e.g., be a minimum change of the sum of the cost functions or reaching a predefined number of training steps. It shall be noted that the maximum complexity remains unchanged during the repetition. As an alternative, the maximum complexity may be reduced with increasing progress of the training.

In subsequent step S24, the channels are removed from the neural network, for which indicator function Φ outputs the value 0. As an alternative, the channels may be organized in a list with respect to their assigned scaling factors γ, the channels being removed from the neural network having the smallest values for γ the predefined number of the multiplications and parameters.

In one further exemplary embodiment, steps S23 and S24 may be consecutively executed multiple times for a predefinable number. In the process, step S23 may be repeated multiple times each time until the abort criterion is met.

After the removal of the channels, the neural network may be trained again, however now using only the first cost function, preferably over three epochs.

Optimally, step S25 may follow. The compressed neural network may be operated herein. It may then classify, in particular, segment, images as a classifier.

In the event that the neural network includes one or a multitude of bridging connection(s) (shortcut connection(s)), the removal of weights/filters may be made more difficult since already deactivated channels may be activated via these connections.

However, bridging connections do not pose a problem for the method according to the present invention. The reason is that, in the event that a layer receives a further output variable of a preceding layer via a bridging connection, the sum from scaling factors γ which have scaled the two output variables may be calculated, which is then provided as an argument to indicator function Φ(γ₁+γ₂,t).

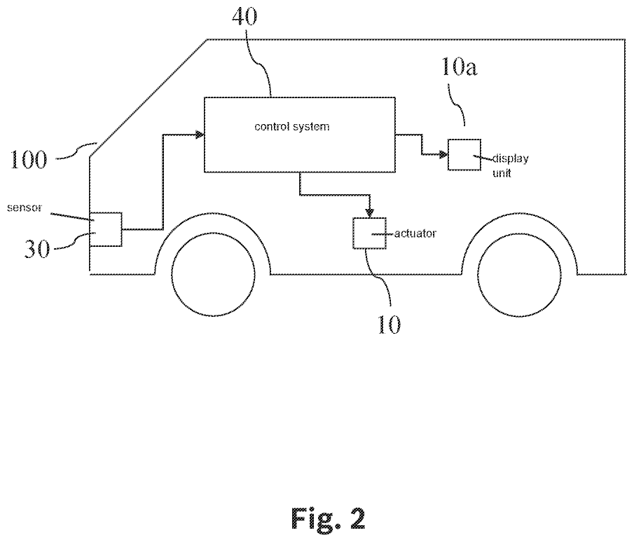

The neural network obtained according to the above-described method may be used as shown by way of example in FIGS. 2 through 7.

At preferably regular intervals, surroundings are detected with the aid of a sensor 30, in particular an imaging sensor, such as a video sensor, which may be provided by a multitude of sensors, for example a stereo camera. Other imaging sensors are also possible, such as for example radar, ultrasound or LIDAR. An infrared camera is also possible. Sensor signal S, or in the case of multiple sensors a respective sensor signal S, of sensor 30 is communicated to a control system 40. Control system 40 thus receives a sequence of sensor signals S. Control system 40 ascertains activation signals A therefrom, which are transferred to actuator 10.

Control system 40 receives the sequence of sensor signals S of sensor 30 in an optional receiving unit, which converts the sequence of sensor signals S into a sequence of input images x (alternatively, it is also possible to directly adopt the respective sensor signal S as input image x). Input image x may, for example, be a portion or a further processing of sensor signal S. Input image x includes individual frames of a video recording. In other words, input image x is ascertained as a function of sensor signal S. The sequence of input images x is supplied to the compressed neural network.

The compressed neural network is preferably parameterized by parameters ϕ which are stored in a parameter memory P and provided thereby.

The compressed neural network ascertains output variables y from the input images x. These output variables y may, in particular, encompass a classification and/or a semantic segmentation of input images x. Output variables y are supplied to an optional conversion unit, which ascertains activation signals A therefrom, which are supplied to actuator 10 to accordingly activate actuator 10. Output variable y encompasses pieces of information about objects which sensor 30 has detected.

Actuator 10 receives activation signals A, is accordingly activated, and carries out a corresponding action. Actuator 10 may include a (not necessarily structurally integrated) activation logic, which ascertains a second activation signal, with which actuator 10 is then activated, from activation signal A.

In further specific embodiments, control system 40 includes sensor 30. In still further specific embodiments, control system 40 alternatively or additionally also includes actuator 10.

In further preferred specific embodiments, control system 40 includes one or multiple processor(s) 45 and at least one machine-readable memory medium 46 on which instructions are stored which, when they are executed on processors 45, prompt control system 40 to execute the method according to the present invention.

In alternative specific embodiments, a display unit 10a is provided as an alternative or in addition to actuator 10.

FIG. 2 shows how control system 40 may be used for controlling an at least semi-autonomous robot, here an at least semi-autonomous motor vehicle 100.

Sensor 30 may, for example, be a video sensor preferably situated in motor vehicle 100.

Artificial neural network 60 is configured to reliably identify objects from input images x.

Actuator 10 preferably situated in motor vehicle 100 may, for example, be a brake, a drive or a steering system of motor vehicle 100. Activation signal A may then be ascertained in such a way that actuator or actuators 10 is/are activated in such a way that motor vehicle 100, for example, prevents a collision with the objects reliably identified by artificial neural network 60, in particular, when objects of certain classes, e.g., pedestrians, are involved.

As an alternative, the at least semi-autonomous robot may also be another mobile robot (not shown), for example one which moves by flying, swimming, diving or walking. The mobile robot may, for example, also be an at least semi-autonomous lawn mower or an at least semi-autonomous cleaning robot. Activation signal A may also be ascertained in these cases in such a way that drive and/or steering system of the mobile robot is/are activated in such a way that the at least semi-autonomous robot, for example, prevents a collision with the objects identified by the compressed neural network.

As an alternative or in addition, display unit 10a may be activated using activation signal A, and, for example, the ascertained safe areas may be represented. It is also possible in the case of a motor vehicle 100 including non-automated steering, for example, that display unit 10a is activated, using activation signal A, in such a way that it outputs a visual or an acoustic warning signal when it is ascertained that motor vehicle 100 is at risk of colliding with one of the reliably identified objects.

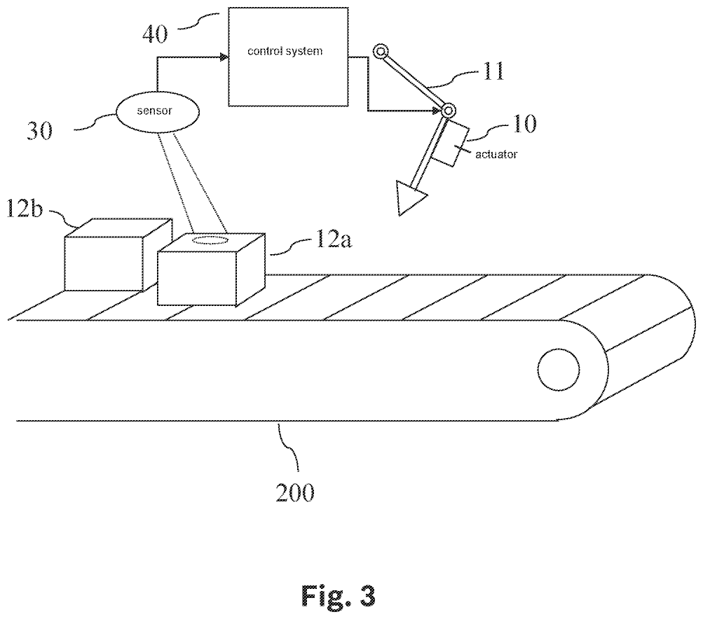

FIG. 3 shows one exemplary embodiment in which control system 40 is used for activating a manufacturing machine 11 of a manufacturing system 200, in that an actuator 10 controlling this manufacturing machine 11 is activated. Manufacturing machine 11 may, for example, be a machine for punching, sawing, drilling and/or cutting.

Sensor 30 may be an optical sensor, for example, which, e.g., detects properties of manufacturing products 12a, 12b. It is possible that these manufacturing products 12a, 12b are movable. It is possible that actuator 10 controlling manufacturing machine 11 is activated as a function of an assignment of the detected manufacturing products 12a, 12b, so that manufacturing machine 11 accordingly executes a subsequent processing step of the correct one of manufacturing products 12a, 12b. It is also possible that manufacturing machine 11 accordingly adapts the same manufacturing step for a processing of a subsequent manufacturing product by identifying the correct properties of the same of manufacturing products 12a, 12b (i.e., without a misclassification).

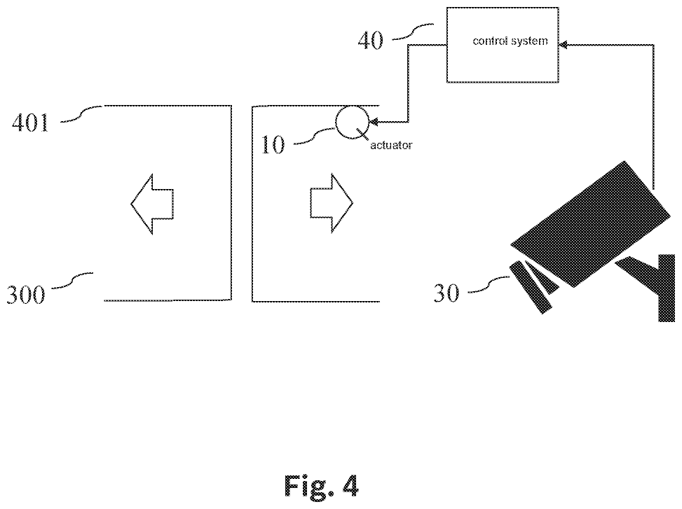

FIG. 4 shows one exemplary embodiment in which control system 40 is used for controlling an access system 300. Access system 300 may encompass a physical access control, for example a door 401. Video sensor 30 is configured to detect a person. This detected image may be interpreted with the aid of object identification system 60. If multiple persons are detected simultaneously, it is possible, for example, to ascertain the identity of the person particularly reliably by an assignment of the person (i.e., of the objects) with respect to one another, for example by an analysis of their movements. Actuator 10 may be a lock which unblocks, or does not unblock, the access control as a function of activation signal A, for example opens, or does not open, door 401. For this purpose, activation signal A may be selected as a function of the interpretation of object identification system 60, for example as a function of the ascertained identity of the person. Instead of the physical access control, a logical access control may also be provided.

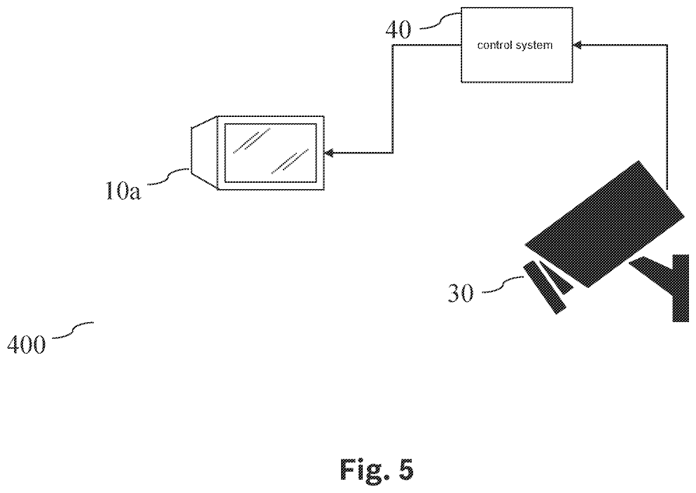

FIG. 5 shows one exemplary embodiment in which control system 40 is used for controlling a monitoring system 400. This exemplary embodiment differs from the exemplary embodiment shown in FIG. 5 in that, instead of actuator 10, display unit 10a is provided, which is activated by control system 40. For example, an identity of the objects recorded by video sensor 30 may be reliably ascertained by artificial neural network 60 in order to infer, e.g., which objects become suspect, and activation signal A may then be selected in such a way that this object is represented highlighted in color by display unit 10a.

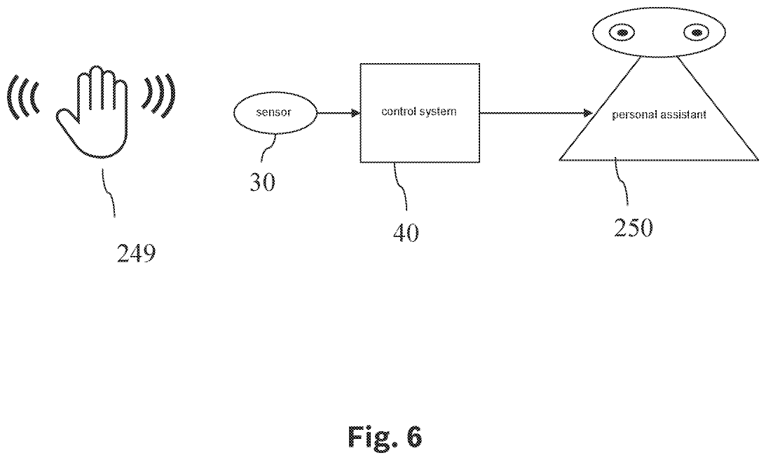

FIG. 6 shows one exemplary embodiment in which control system 40 is used for controlling a personal assistant 250. Sensor 30 is preferably an optical sensor which receives images of a gesture of a user 249.

As a function of the signals of sensor 30, control system 40 ascertains an activation signal A of personal assistant 250, for example in that the neural network carries out a gesture recognition. This ascertained activation signal A is then communicated to personal assistant 250, and it is thus accordingly activated. This ascertained activation signal A may then, in particular, be selected in such a way that it corresponds to a presumed desired activation by user 249. This presumed desired activation may be ascertained as a function of the gesture recognized by artificial neural network 60. Control system 40 may then, as a function of the presumed desired activation, select activation signal A for the communication to personal assistant 250 and/or select activation A for the communication to the personal assistant corresponding to the presumed desired activation 250.

This corresponding activation may, for example, include that personal assistant 250 retrieves pieces of information from a database, and reproduces them apprehensible for user 249.

Instead of personal assistant 250, a household appliance (not shown), in particular, a washing machine, a stove, an oven, a microwave or a dishwasher may also be provided to be accordingly activated.

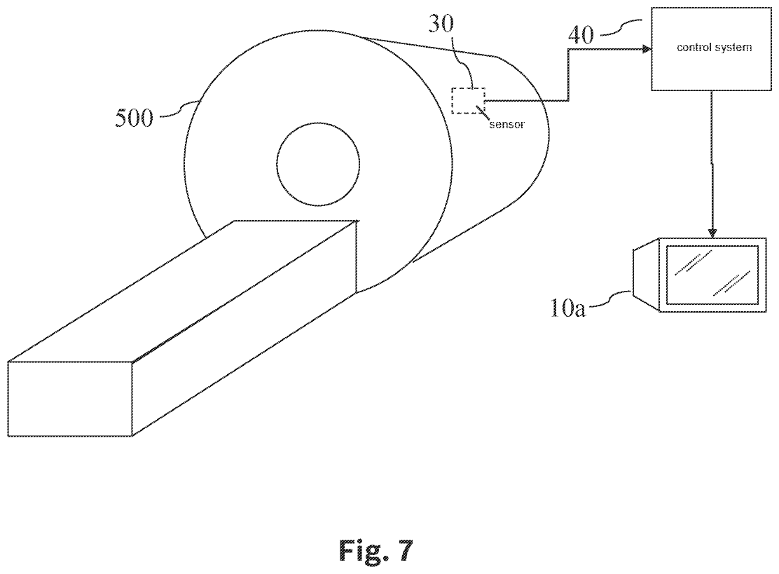

FIG. 7 shows one exemplary embodiment in which control system 40 is used for controlling a medical imaging system 500, for example an MRI, X-ray or ultrasound device. Sensor 30 may, for example, be an imaging sensor, and display unit 10a is activated by control system 40. For example, it may be ascertained by neural network 60 whether an area recorded by the imaging sensor is conspicuous, and activation signal A may then be selected in such a way that this area is represented highlighted in color by display unit 10a.

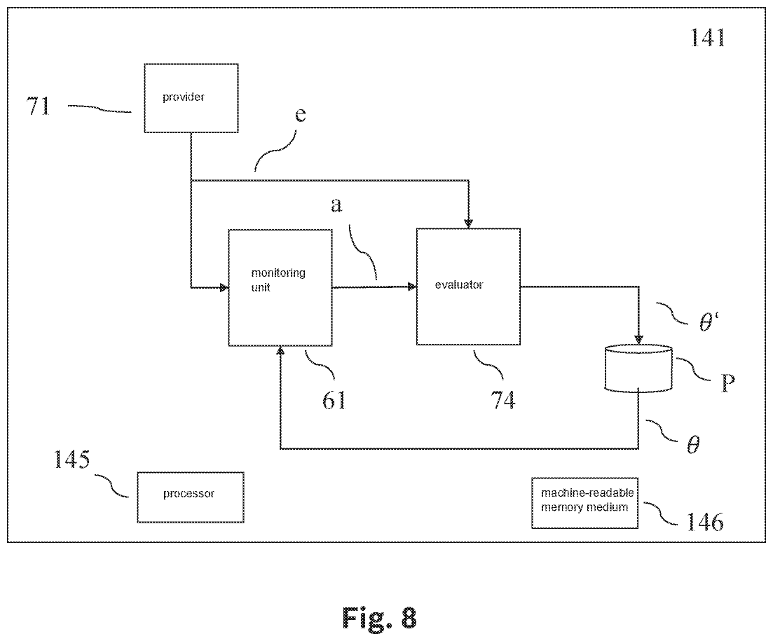

FIG. 8 schematically shows a training device 141 which includes a provider 71, which provides input images e from a training data set. Input images e are supplied to monitoring unit 61 to be trained, which ascertains output variables a therefrom. Output variables a and input images e are supplied to an evaluator 74, which ascertains new parameters θ′ therefrom, as described in connection with FIG. 10, which are conveyed to parameter memory P, and replace parameters θ there.

The methods executed by training device 141 may be stored on a machine-readable memory medium 146, implemented as a computer program, and executed by a processor 145.

The term “computer” encompasses arbitrary devices for processing predefinable computing rules. These computing rules may be present in the form of software, or in the form of hardware, or also in a mixed form made up of software and hardware.

What is claimed is:

1. A computer-implemented method for compressing a neural network, the neural network including at least one sequence of a first layer, which carries out a weighted summation of input variables of the first layer as a function of a multitude of weightings, and a second layer, which carries out an affine transformation as a function of scaling factors of input variables of the second layer, weightings of the first layer each being assigned a scaling factor from the second layer, the method comprising the following steps:
defining a maximum complexity, the complexity characterizing a consumption of computer resources of the first layer;
ascertaining a first cost function which characterizes a deviation of ascertained output variables of the neural network in relation to predefined output variables from training data;
ascertaining a second cost function which characterizes a deviation of a current complexity of the neural network in relation to the maximum complexity, the current complexity being ascertained as a function of a number of the scaling factors which have an absolute value greater than a predefined threshold value;
training the neural network in such a way that a sum of the first cost function and the second cost function is optimized as a function of the weightings and the scaling factors of the neural network; and
removing those weightings of the first layer whose assigned scaling factor has an absolute value smaller than the predefined threshold value.

2. The method as recited in claim 1, wherein a current number of scaling factors is ascertained using a sum of indicator functions, applied to each scaling of the scaling factors, the indicator function outputting a value 1 when an absolute value of the scaling factor is greater than the threshold value, and otherwise outputting a value 0, the current complexity being ascertained as a function of the sum of the indicator functions, standardized to a number of the calculated weightings of the first layer, multiplied with a number of parameters or multiplications of the first layer.

3. The method as recited in claim 2, wherein the neural network includes a multitude of sequences of the first and second layers, the complexity of the first layers being ascertained as a function of the sum of the indicator functions, standardized to a number of the calculated weightings of the first layer, the current complexity being ascertained as the sum across the complexities of the first layers, which is multiplied in each case with a complexity of an immediately preceding first layer of the respective first layer, and multiplied with the number of parameters or multiplications from the respective first layer.

4. The method as recited in claim 1, wherein the first layer is a convolutional layer, and the weightings are filters, each of the scaling factors being assigned to a respective filter of the convolutional layer.

5. The method as recited in claim 1, wherein the complexity is defined as a function of an architecture of a processing unit on which the compressed neural network is to be executed.

6. The method as recited in claim 1, wherein the predefined threshold value is t=10⁻⁴.

7. The method as recited in claim 3, wherein one of the first layers is connected via a bridging connection to a further preceding layer of the neural network, the indicator function being applied to a sum of the scaling factors of two preceding layers.

8. The method as recited in claim 1, wherein the second cost function is scaled with a factor, the factor being selected in such a way that a value of the scaled second cost function corresponds to an ascertained value of the first cost function at a beginning of the training.

9. The method as recited in claim 8, wherein, at the beginning of the training, the factor of the second cost function is initialized using a value 1 and, during repeated execution of the step of training, the factor is steadily increased until the factor corresponds to the ascertained value of the first cost function at the beginning of the training.

10. The method as recited in claim 1, wherein, after the step of removing the weightings, the neural network is partially subsequently trained as a function of the first cost function.

11. The method as recited in claim 1, wherein the complexity characterizes a number of multiplications of the first layer or a number of parameters of the first layer or a number of output variables of the first layer.

12. The method as recited in claim 11, wherein the complexity characterizes a number of multiplications and parameters, the second cost function characterizing a sum of the deviation of the current complexity and predefined complexity with respect to the number of parameters and the number of multiplications.

13. The method as recited in claim 1, further comprising:
using the compressed neural network as an image classifier.

14. A device configured to compress a neural network, the neural network including at least one sequence of a first layer, which carries out a weighted summation of input variables of the first layer as a function of a multitude of weightings, and a second layer, which carries out an affine transformation as a function of scaling factors of input variables of the second layer, weightings of the first layer each being assigned a scaling factor from the second layer, the device configured to:
define a maximum complexity, the complexity characterizing a consumption of computer resources of the first layer;
ascertain a first cost function which characterizes a deviation of ascertained output variables of the neural network in relation to predefined output variables from training data;
ascertain a second cost function which characterizes a deviation of a current complexity of the neural network in relation to the maximum complexity, the current complexity being ascertained as a function of a number of the scaling factors which have an absolute value greater than a predefined threshold value;
train the neural network in such a way that a sum of the first cost function and the second cost function is optimized as a function of the weightings and the scaling factors of the neural network; and
remove those weightings of the first layer whose assigned scaling factor has an absolute value smaller than the predefined threshold value.

15. A non-transitory machine-readable memory medium on which is stored a computer program for compressing a neural network, the neural network including at least one sequence of a first layer, which carries out a weighted summation of input variables of the first layer as a function of a multitude of weightings, and a second layer, which carries out an affine transformation as a function of scaling factors of input variables of the second layer, weightings of the first layer each being assigned a scaling factor from the second layer, the computer program, when executed by a computer, causing the computer to perform the following steps:
defining a maximum complexity, the complexity characterizing a consumption of computer resources of the first layer;
ascertaining a first cost function which characterizes a deviation of ascertained output variables of the neural network in relation to predefined output variables from training data;
ascertaining a second cost function which characterizes a deviation of a current complexity of the neural network in relation to the maximum complexity, the current complexity being ascertained as a function of a number of the scaling factors which have an absolute value greater than a predefined threshold value;
training the neural network in such a way that a sum of the first cost function and the second cost function is optimized as a function of the weightings and the scaling factors of the neural network; and
removing those weightings of the first layer whose assigned scaling factor has an absolute value smaller than the predefined threshold value.
